(19) United States
(12) Patent Application Publication
(10) Pub. No.: US 2024/0259928 A1
(43) Pub. Date: Aug. 1, 2024

(54) APPARATUS, SYSTEM, AND METHOD OF FREQUENCY BANDWIDTH (BW) BLOCKING FOR WIRELESS COMMUNICATION

(71) Applicants: Shahrnaz Azizi, Cupertino, CA (US); Niranjan Mylarappa Gowda, Hillsboro, OR (US); Laurent Cariou, Milizac (FR); Eduardo Alban, Hillsboro, OR (US); Thomas Kenney, Portland, OR (US); Chen Kojokaro, Yoqneam Illit (IL)

(72) Inventors: Shahrnaz Azizi, Cupertino, CA (US); Niranjan Mylarappa Gowda, Hillsboro, OR (US); Laurent Cariou, Milizac (FR); Eduardo Alban, Hillsboro, OR (US); Thomas Kenney, Portland, OR (US); Chen Kojokaro, Yoqneam Illit (IL)

(21) Appl. No.: 18/635,334

(22) Filed: Apr. 15, 2024

(51) Int. Cl. H04W 48/16; H04B 17/336; H04L 1/00

(52) U.S. Cl. CPC H04W 48/16; H04B 17/336; H04L 1/0068

(57) ABSTRACT

For example, an apparatus may include logic and circuitry configured to cause a non Access Point (AP) (non-AP) station (STA) to identify at least one STA-blocked frequency bandwidth (BW) to be blocked for communication between the non-AP STA and an AP in a wireless communication frequency channel. For example, the non-AP STA may be configured to transmit a STA-initiated block request to the AP. For example, the STA-initiated block request may be configured to indicate a request from the non-AP STA to the AP to block the STA-blocked frequency BW for the communication between the non-AP STA and the AP.

### BACKGROUND

Devices in a wireless communication system may be configured to communicate over one or more wireless communication channels.

For example, devices in a wireless communication system may be configured to communicate transmissions over various channel bandwidths.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of interference measurements for two different workloads, in accordance with some demonstrative aspects.

FIG. 3 is a schematic illustration of simulation results of Packet Error Ratio (PER) versus thermal noise variance for simulated data transmissions, in accordance with some demonstrative aspects.

FIG. 4 is a schematic illustration of simulation results of PER versus thermal noise power for simulated data transmissions, in accordance with some demonstrative aspects.

FIG. 5 is a schematic flow-chart illustration of a method of frequency bandwidth (BW) blocking for wireless communication, in accordance with some demonstrative aspects.

FIG. 6 is a schematic flow-chart illustration of a method of frequency BW blocking for wireless communication, in accordance with some demonstrative aspects.

FIG. 7 is a schematic flow-chart illustration of a method of frequency BW blocking for wireless communication, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn Ultra High Reliability (UHR))) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHZ channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHZ, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

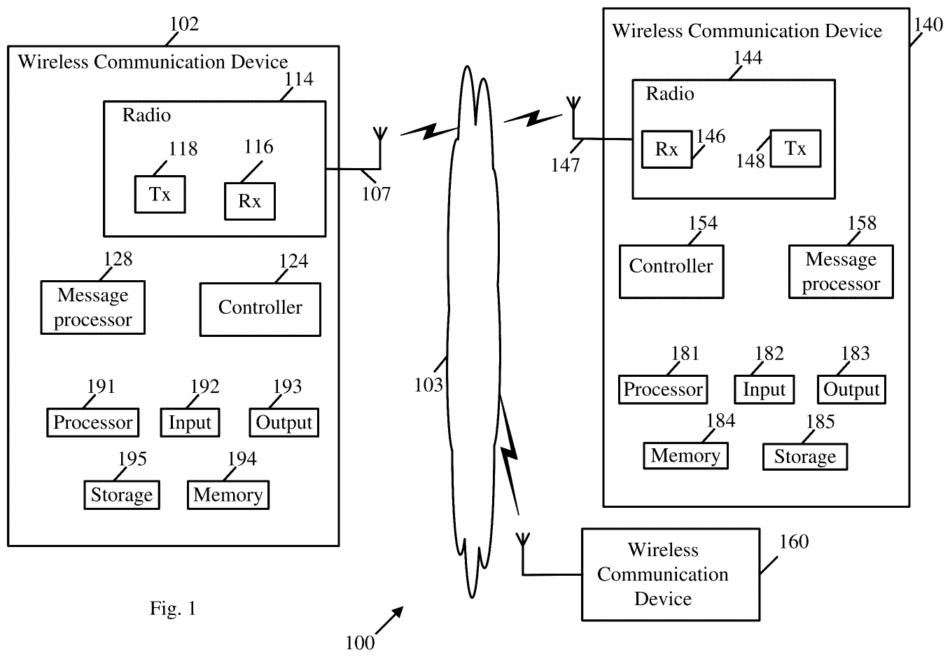

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mm Wave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to implement one or more operations and/or functionalities of a frequency bandwidth (BW) blocking mechanism, which may be configured to block one or more blocked frequency BWs in a wireless communication frequency channel, e.g., as described below.

In some demonstrative aspects, device 102, device 140, and/or device 160 may be configured to implement one or more operations and/or functionalities of a frequency BW blocking mechanism, which may be configured to block one or more STA-blocked frequency BWs in a wireless communication frequency channel, e.g., as described below.

In some demonstrative aspects, device 102, device 140, and/or device 160 may be configured to implement one or more operations and/or functionalities of a frequency BW blocking mechanism, which may be configured to block one or more AP-blocked frequency BWs in a wireless communication frequency channel, e.g., as described below.

In some demonstrative aspects, device 102, device 140, and/or device 160 may be configured to identify a blocked frequency BW to be blocked, for example, based on an identified interference over the blocked frequency BW, e.g., as described below.

In some demonstrative aspects, the blocked frequency BW may include a STA-blocked frequency BW, which may be identified by a non-AP STA, e.g., a non-AP STA implemented by device 140, e.g., as described below.

In some demonstrative aspects, the non-AP STA may be configured to identify the STA-blocked frequency BW to be blocked, for example, based on an identified interference over the STA-blocked frequency BW, e.g., as described below.

In some demonstrative aspects, the blocked frequency BW may include an AP-blocked frequency BW, which may be identified by an AP, e.g., an AP implemented by device 102, e.g., as described below.

In some demonstrative aspects, the AP may be configured to identify the AP-blocked frequency BW to be blocked, for example, based on an identified interference over the AP-blocked frequency BW, e.g., as described below.

In some demonstrative aspects, a STA, e.g., an AP implemented by device 102 and/or a non-AP STA implemented by device 140, may be configured to identify the blocked frequency BW, for example, based on an identified platform interference over the blocked frequency BW, e.g., as described below.

In some demonstrative aspects, the identified platform interference may include interference from one or more platform components of a platform including the STA, e.g., as described below.

In some demonstrative aspects, the STA, e.g., the AP implemented by device 102 and/or the non-AP STA implemented by device 140, may be configured to identify the blocked frequency BW, for example, based on one or more real-time operation parameters of one or more platform components of the platform including the STA, e.g., as described below.

In some demonstrative aspects, the STA, e.g., the AP implemented by device 102 and/or the non-AP STA implemented by device 140, may be configured to identify the blocked frequency BW, for example, based on an identified performance degradation over the STA-blocked frequency BW, e.g., as described below.

In some demonstrative aspects, the STA, e.g., the AP implemented by device 102 and/or the non-AP STA implemented by device 140, may be configured to identify the blocked frequency BW, for example, based on an identified Radio-Frequency Interference (RFI) over the blocked frequency BW, e.g., as described below.

In other aspects, the blocked frequency BW, e.g., a STA-blocked frequency BW and/or an AP-blocked frequency BW, may be identified based on any other additional and/or alternative criteria.

In some demonstrative aspects, device 102, device 140, and/or device 160 may be configured to implement one or more operations and/or functionalities of a frequency BW blocking mechanism, for example, to address one or more technical issues of a degradation of Wi-Fi performance due to a platform interference (also referred to as an “in-device self-interference”), e.g., as described below.

For example, the platform interference may include interference (“noise”), which may be caused by one or more platform components, e.g., as described below.

In one example, the platform interference may be caused by clock frequency of a memory, e.g., a Double Data Rate (DDR) memory, a Low-Power Double Data Rate (LPDDR) memory, and/or any other type of memory.

In another example, the platform interference may be caused by any other additional and/or alternative source of interference, which may be generated by any other additional or alternative platform components including, for example, a high-speed Input/Output (I/O), a display clock, a camera, a Bluetooth device, e.g., which may be integrated with Wi-Fi, and/or any other additional or alternative components.

In some demonstrative aspects, device 102, device 140, and/or device 160 may be configured to implement one or more operations and/or functionalities of a frequency BW blocking mechanism, for example, to address one or more technical issues of the platform interference, which may affect a Multi-Link Operation (MLO), e.g., as described below.

In some demonstrative aspects, device 102, device 140, and/or device 160 may be configured to communicate according to an MLO mechanism, which may implement one or more operations and/or functionalities for communication at an Enhanced Multilink Single-Radio (EMLSR) operation mode, e.g., in accordance with an IEEE 802.11be Specification.

For example, the EMLSR operation mode may be defined, e.g., in compliance with an IEEE 802.11be Specification, to include a mode of operation that allows a non-AP STA with multiple receive chains to listen on a set of enabled links, for example, when the non-AP STA is in an awake state, for an initial control frame sent by an AP. For example, the initial control frame may be sent by the AP in a non-high-throughput (non-HT) (duplicate) PPDU, for example, with one spatial stream. For example, the initial control frame may be followed by one or more frame exchanges on the link on which the initial Control frame was received. In other aspects, the EMLSR operation mode may be defined to include any other additional or alternative suitable functionality.

In some demonstrative aspects, device 102, device 140, and/or device 160 may be configured to implement one or more operations and/or functionalities of an MLO mechanism, which may be configured to support a Tri-band Dual Concurrency (TBDC) operation mode, for example, to support concurrent Transmit/Receive operation over a number of physical channels, for example, over two or more radios in two or more Wi-Fi bands.

For example, a possibility of WLAN performance degradation, e.g., due to in-device self-interference, may increase, e.g., as the number of physical channels increases.

In some demonstrative aspects, for example, in some implementations, scenarios, use cases, and/or deployments, it may be inefficient to address the in-device self-interference by changing a clock frequency of platform component causing the in-device self-interference, e.g., a clock frequency of the DDR/LPDDR memory, for example to protect a channel at a given time. For example, such an implementation may require additional hardware, software, and/or memory training costs, for example, to support the MLO operation mode. For example, any new memory operation speed may require validation and/or tuning, which may require additional resources and/or time to market. Moreover, the time to perform a new memory training may add to the already very restricted boot time, which may make addition of a new memory speed inefficient, or even impossible.

For example, an implementation which is configured to change the clock frequency of the DDR/LPDDR memory may require changing a DDR/LPDDR Dynamic Voltage Frequency Scaling (DVFS) point, for example, to select a memory speed that may not interfere on a Wi-Fi channel. For example, adding a DVFS point, or changing a DVFS point, may require new memory training sequences, which, in turn, may require hardware space to store them. For example, a new memory training sequence may, e.g., must, be tested, validated, and/or tuned for each platform model.

For example, in some implementations, scenarios, use cases, and/or deployments, a memory training may happen during boot-time, while there may already be relatively stringent requirements to reduce the boot time.

For example, in some implementations, scenarios, use cases, and/or deployments, the change of a DVFS point may come with a cost to memory performance. For example, in the absence of Wi-Fi operation, the memory clock may be selected, for example, based on a relatively complex platform performance tuning algorithm such that, for a given power, thermal and acoustic budget, the speed of the memory is optimized.

For example, a request from a Wi-Fi module to change the DVFS point to avoid interference to wireless communication may force the platform to skip a clock frequency, to go one step higher in frequency or one step lower.

For example, if the platform drops the clock frequency to a lower frequency, memory performance may decrease, for example, since it may take longer to finish a task for an end user.

For example, operating the platform at a memory frequency above or below its optimal operating point may cause an increase of power consumption, which may impact an overall battery life. Therefore, operating at an optimal point may be important, e.g., for the end user experience.

For example, in some implementations, scenarios, use cases, and/or deployments, although not often, in order to meet workload demands, a battery life target and/or thermal restrictions, the platform may ignore the Wi-Fi module request to change the DVFS point. As a result, the in-device self-interference may remain on a Wi-Fi channel, which may trigger catastrophic connectivity scenarios.

In one example, in one use case a video may be downloaded and processed in real time, and then the processed video may be uploaded to a server, for example, by using Wi-Fi links for both operations. Moreover, this video processing task may run on a laptop, which may be working only on battery power (not plugged). According to this example, in order to meet performance demand and/or power budget, a complex platform tuning algorithm may decide to continue operating on a selected DVFS point, which may interfere with at least one of the Wi-Fi links. As a result, the interference on the Wi-Fi links may, e.g., would, degrade download and/or upload performance, which may impact the end user experience of observing a choppy video.

In another example, the platform selects to honor the Wi-Fi module request by stepping a memory frequency down, which may lead to a degraded memory performance, which, in turn, may, e.g., would, add latency to the end user application.

In another example, the platform selects to honor the Wi-Fi module request by increasing a memory frequency, which may lead to a relatively quick drain of the battery, thus resulting in the total disappointment of the end user, and/or overheating of the platform.

In some demonstrative aspects, device 102, device 140, and/or device 160 may be configured to implement one or more operations and/or functionalities of a frequency BW blocking mechanism, which may be configured to block one or more blocked frequency BWs in a wireless communication frequency channel, e.g., as described below.

In some demonstrative aspects, device 102, device 140, and/or device 160 may be configured to implement one or more operations and/or functionalities of a frequency BW blocking mechanism, which may be configured to block one or more STA-blocked frequency BWs in a wireless communication frequency channel, e.g., as described below.

In some demonstrative aspects, the frequency BW blocking mechanism may be configured to implement one or more operations and/or functionalities of a negotiation mechanism, which may be configured to support blocking of one or more STA-blocked frequency BWs, e.g., as described below.

In some demonstrative aspects, the negotiation mechanism may be configured to support a non-AP STA to negotiate with an AP to block a certain part of a band, e.g., as described below.

For example, the blocking of one or more STA-blocked frequency BWs may provide a technical solution to enhance Wi-Fi performance and/or platform performance at a client device, e.g., as described below.

For example, the blocking of one or more STA-blocked frequency BWs may provide a technical solution to prevent extra packet retries over the air, and/or extra link adaptation procedures at the AP. Accordingly, blocking of one or more STA-blocked frequency BWs may provide a technical solution to improve overall network performance

For example, in-device self-interference (platform interference) may impact a packet error rate and/or a success rate at a client receiver, for example, while a client transmitter may continue transmitting higher modulation and/or coding rates to the AP. This situation may lead to an imbalanced link condition.

For example, in some implementations, scenarios, use cases, and/or deployments, a link adaptation procedure at the AP, which may be an implementation choice of an AP vendor, may consider channel reciprocity and/or a rate at which the AP successfully receives packets. As a result, an imbalanced link due to the client's in-device self-interference may mislead the link adaptation procedure of the AP, which may further negatively impact network efficiency.

In some demonstrative aspects, device 102, device 140, and/or device 160 may be configured to implement one or more operations and/or functionalities of a frequency BW blocking mechanism, for example, to improve end user experience, e.g., as described below.

In some demonstrative aspects, device 102, device 140, and/or device 160 may be configured to implement one or more operations and/or functionalities of a frequency BW blocking mechanism, for example, to improve power, thermal and/or performance optimization, e.g., as described below.

In some demonstrative aspects, device 102, device 140, and/or device 160 may be configured to implement one or more operations and/or functionalities of a frequency BW blocking mechanism, for example, to improve Wi-Fi performance, e.g., as described below.

In some demonstrative aspects, device 102, device 140, and/or device 160 may be configured to implement one or more operations and/or functionalities of a frequency BW blocking mechanism, for example, to improve overall wireless network utilization, e.g., as described below.

In some demonstrative aspects, controller 154 may be configured to control, trigger, cause, and/or instruct a non-AP STA implemented by device 140 to identify at least one STA-blocked frequency BW to be blocked for communication between the non-AP STA and an AP, e.g., an AP implemented by device 102, in a wireless communication frequency channel, e.g., as described below.

In some demonstrative aspects, controller 154 may be configured to control, trigger, cause, and/or instruct the non-AP STA implemented by device 140 to transmit a STA-initiated block request to the AP, e.g., as described below.

In some demonstrative aspects, the STA-initiated block request may be configured to indicate a request from the non-AP STA to the AP to block the STA-blocked frequency BW for the communication between the non-AP STA and the AP, e.g., as described below.

In some demonstrative aspects, the STA-initiated block request may be configured to indicate a request from the non-AP STA to the AP to block the STA-blocked frequency BW for any data transmission from the AP to the non-AP STA, e.g., as described below.

In other aspects, the STA-initiated block request may be configured to indicate a request from the non-AP STA to the AP to block the STA-blocked frequency BW for any other additional or alternative transmission from the AP to the non-AP STA.

In some demonstrative aspects, controller 154 may be configured to control, trigger, cause, and/or instruct the non-AP STA implemented by device 140 to process a response from the AP, for example, to identify whether or not the STA-initiated block request is approved by the AP, e.g., as described below.

In some demonstrative aspects, controller 154 may be configured to control, trigger, cause, and/or instruct the non-AP STA implemented by device 140 to identify the STA-blocked frequency BW, for example, based on an identified interference over the STA-blocked frequency BW, e.g., as described below.

In some demonstrative aspects, controller 154 may be configured to control, trigger, cause, and/or instruct the non-AP STA implemented by device 140 to identify the STA-blocked frequency BW, for example, based on an identified platform interference over the STA-blocked frequency BW, e.g., as described below.

In some demonstrative aspects, the identified platform interference may include interference from one or more platform components of a platform including the non-AP STA, e.g., as described below.

In some demonstrative aspects, controller 154 may be configured to control, trigger, cause, and/or instruct the non-AP STA implemented by device 140 to identify the STA-blocked frequency BW, for example, based on an identified interference from a memory of a platform including the non-AP STA, e.g., as described below.

In other aspects, the non-AP STA implemented by device 140 may identify the STA-blocked frequency BW, for example, based on an identified interference from any other additional and/or alternative platform components.

In some demonstrative aspects, controller 154 may be configured to control, trigger, cause, and/or instruct the non-AP STA implemented by device 140 to identify the STA-blocked frequency BW, for example, based on one or more real-time operation parameters of one or more platform components of a platform including the non-AP STA, e.g., as described below.

In other aspects, the non-AP STA implemented by device 140 may identify the STA-blocked frequency BW, for example, based on any other additional or alternative parameters of the one or more platform components.

In some demonstrative aspects, controller 154 may be configured to control, trigger, cause, and/or instruct the non-AP STA implemented by device 140 to identify the STA-blocked frequency BW, for example, based on an identified performance degradation over the STA-blocked frequency BW, e.g., as described below.

In some demonstrative aspects, controller 154 may be configured to control, trigger, cause, and/or instruct the non-AP STA implemented by device 140 to identify the STA-blocked frequency BW, for example, based on an identified Radio-Frequency Interference (RFI) over the STA-blocked frequency BW, e.g., as described below.

In other aspects, the non-AP STA may identify the STA-blocked frequency BW based on any other additional or alternative criteria and/or parameters.

In some demonstrative aspects, controller 154 may be configured to control, trigger, cause, and/or instruct the non-AP STA implemented by device 140 to transmit the STA-initiated block request, which may include a duration field to indicate a duration for blocking the STA-blocked frequency BW for the non-AP STA, e.g., as described below.

In some demonstrative aspects, controller 154 may be configured to control, trigger, cause, and/or instruct the non-AP STA implemented by device 140 to transmit a termination message to request the AP to terminate blocking of the STA-blocked frequency BW for the non-AP STA, e.g., as described below.

In some demonstrative aspects, the STA-initiated block request may include a STA-initiated puncturing request to request the AP to puncture the STA-blocked frequency BW for the STA, e.g., as described below.

In some demonstrative aspects, controller 154 may be configured to control, trigger, cause, and/or instruct the non-AP STA implemented by device 140 to transmit the STA-initiated block request in a parameter update request, e.g., as described below.

In some demonstrative aspects, the parameter update request may include one or more parameters to be updated, for example, according to an operation mode of the non-AP STA, e.g., as described below.

In some demonstrative aspects, controller 154 may be configured to control, trigger, cause, and/or instruct the non-AP STA implemented by device 140 to transmit the STA-initiated block request, which may indicate a request from the non-AP STA to the AP, for example, to block the STA-blocked frequency BW for any Resource Unit (RU) allocation to be provided by the AP to the non-AP STA, e.g., as described below.

In some demonstrative aspects, the STA-initiated block request may include an indication of a STA-blocked RU, which includes the STA-blocked frequency BW, e.g., as described below.

In some demonstrative aspects, the STA-initiated block request may be configured to indicate to the AP a request to block the STA-blocked RU and any other additional RU having an overlap with the STA-blocked RU, e.g., as described below.

In some demonstrative aspects, the STA-initiated block request may include a bitmap including a plurality of bits corresponding to a plurality of RUs, e.g., as described below.

In some demonstrative aspects, a bit value of a bit in the bitmap may indicate whether or not an RU corresponding to the bit is to be blocked for the non-AP STA, e.g., as described below.

In some demonstrative aspects, the STA-initiated block request may include a blocked RU field, e.g., as described below.

In some demonstrative aspects, the blocked RU field may include a predefined RU-set value selected from a plurality of predefined RU-set values, e.g., as described below.

In some demonstrative aspects, the plurality of predefined RU-set values may be mapped to a plurality of predefined RU sets, respectively, e.g., as described below.

In some demonstrative aspects, the predefined RU-set value may indicate a set of one or more RUs having an overlap with the STA-blocked frequency BW, e.g., as described below.

In some demonstrative aspects, the STA-initiated block request may include a center-frequency value, for example, to indicate a center frequency of the STA-blocked frequency BW, e.g., as described below.

In some demonstrative aspects, the STA-initiated block request may include a BW value, for example, to indicate a BW of the STA-blocked frequency BW, e.g., as described below.

In other aspects, the STA-initiated block request may include any other additional or alternative information to indicate the STA-blocked frequency BW.

In some demonstrative aspects, controller 124 may be configured to control, trigger, cause, and/or instruct an AP implemented by device 102 to process a STA-initiated block request from a non-AP STA, for example, to identify a request from the non-AP STA to block a STA-blocked frequency BW for communication between the non-AP STA and the AP, e.g., as described below.

In some demonstrative aspects, controller 124 may be configured to control, trigger, cause, and/or instruct the AP implemented by device 102 to block the STA-blocked frequency BW for communication between the non-AP STA and the AP, for example, based on a determination that the STA-initiated block request is to be approved, e.g., as described below.

In some demonstrative aspects, controller 124 may be configured to control, trigger, cause, and/or instruct the AP implemented by device 102 to block the STA-blocked frequency BW for communication between the non-AP STA and the AP, for example, while allowing the AP to use the STA-blocked frequency BW for communication with one or more other non-AP STAs, e.g., as described below.

In some demonstrative aspects, the STA-initiated block request received by the AP implemented by device 102 may include the STA-initiated block request transmitted by the non-AP STA implemented by device 140, e.g., as described above.

In some demonstrative aspects, controller 124 may be configured to control, trigger, cause, and/or instruct the AP implemented by device 102 to transmit a response to the non-AP STA, for example, to indicate to the non-AP STA whether or not the STA-initiated block request is approved by the AP, e.g., as described below.

In some demonstrative aspects, controller 124 may be configured to control, trigger, cause, and/or instruct the AP implemented by device 102 to determine to block the STA-blocked frequency BW for any data transmission from the AP to the non-AP STA, for example, based on the STA-initiated block request, e.g., as described below.

In some demonstrative aspects, controller 124 may be configured to control, trigger, cause, and/or instruct the AP implemented by device 102 to identify a first request from a first non-AP STA to block a first STA-blocked frequency BW for communication between the first non-AP STA and the AP, e.g., as described below.

In some demonstrative aspects, controller 124 may be configured to control, trigger, cause, and/or instruct the AP implemented by device 102 to identify a second request from a second non-AP STA to block a second STA-blocked frequency BW for communication between the second non-AP STA and the AP, e.g., as described below.

In some demonstrative aspects, the second STA-blocked frequency BW may be different from the first STA-blocked frequency BW, e.g., as described below.

In some demonstrative aspects, controller 124 may be configured to control, trigger, cause, and/or instruct the AP implemented by device 102 to block the first STA-blocked frequency BW for communication between the first non-AP STA and the AP, for example, while allowing the AP to use the first STA-blocked frequency BW for communication with the second non-AP STA, e.g., as described below.

In some demonstrative aspects, controller 124 may be configured to control, trigger, cause, and/or instruct the AP implemented by device 102 to block the second STA-blocked frequency BW for communication between the second non-AP STA and the AP, for example, while allowing the AP to use the second STA-blocked frequency BW for communication with the first non-AP STA, e.g., as described below.

In some demonstrative aspects, controller 124 may be configured to control, trigger, cause, and/or instruct the AP implemented by device 102 to process a duration field in the STA-initiated block request, for example, to identify a duration for blocking the STA-blocked frequency BW for the non-AP STA, e.g., as described below.

In some demonstrative aspects, controller 124 may be configured to control, trigger, cause, and/or instruct the AP implemented by device 102 to process a termination message from the non-AP STA, for example, to identify a request from the non-AP STA to terminate blocking of the STA-blocked frequency BW for the non-AP STA, e.g., as described below.

In some demonstrative aspects, controller 124 may be configured to control, trigger, cause, and/or instruct the AP implemented by device 102 to process a STA-initiated puncturing request from the non-AP STA, for example, to identify a request from the non-AP STA to puncture the STA-blocked frequency BW for the non-AP STA, e.g., as described below.

In some demonstrative aspects, controller 124 may be configured to control, trigger, cause, and/or instruct the AP implemented by device 102 to process a parameter update request, for example, to identify the STA-initiated block request, e.g., as described below.

In some demonstrative aspects, the parameter update request may include one or more parameters to be updated, for example, according to an operation mode of the non-AP STA, e.g., as described below.

In some demonstrative aspects, controller 124 may be configured to control, trigger, cause, and/or instruct the AP implemented by device 102 to determine to block the STA-blocked frequency BW for any RU allocation to be provided by the AP to the non-AP STA, for example, based on the STA-initiated block request, e.g., as described below.

In some demonstrative aspects, the STA-initiated block request may include an indication of a STA-blocked RU, which includes the STA-blocked frequency BW, e.g., as described below.

In some demonstrative aspects, controller 124 may be configured to control, trigger, cause, and/or instruct the AP implemented by device 102 to determine that any RU having an overlap with the STA-blocked RU is to be blocked for communication between the non-AP STA and the AP, e.g., as described below.

In some demonstrative aspects, the STA-initiated block request may include a blocked RU field, e.g., as described below.

In some demonstrative aspects, the blocked RU field may include a predefined RU-set value selected from a plurality of predefined RU-set values mapped to a plurality of predefined RU sets, respectively, e.g., as described below.

In some demonstrative aspects, the predefined RU-set value may indicate a set of one or more RUs having an overlap with the STA-blocked frequency BW, e.g., as described below.

In some demonstrative aspects, the STA-initiated block request may include a bitmap including a plurality of bits corresponding to a plurality of RUs, e.g., as described below.

In some demonstrative aspects, a bit value of a bit in the bitmap may indicate whether or not an RU corresponding to the bit is to be blocked for the non-AP STA, e.g., as described below.

In some demonstrative aspects, the STA-initiated block request may include a center-frequency value, for example, to indicate a center frequency of the STA-blocked frequency BW, e.g., as described below.

In some demonstrative aspects, the STA-initiated block request may include a BW value, for example, to indicate a BW of the STA-blocked frequency BW, e.g., as described below.

In other aspects, controller 124 may be configured to control, trigger, cause, and/or instruct the AP implemented by device 102 to determine the STA-blocked frequency BW based on any other additional or alternative fields and/or values in the STA-initiated block request.

In some demonstrative aspects, device 102, device 140, and/or device 160 may be configured to implement one or more operations and/or functionalities of a frequency BW blocking mechanism, which may be configured to block one or more AP-blocked frequency BWs in a wireless communication frequency channel, e.g., as described below.

In some demonstrative aspects, controller 124 may be configured to control, trigger, cause, and/or instruct an AP implemented by device 102 to identify at least one AP-blocked frequency BW in a wireless communication frequency channel, for example, based on an identified platform interference over the AP-blocked frequency BW, e.g., as described below.

In some demonstrative aspects, the platform interference may include interference from one or more platform components of a platform including the AP, e.g., as described below.

In some demonstrative aspects, controller 124 may be configured to control, trigger, cause, and/or instruct the AP implemented by device 102 to block the AP-blocked frequency BW for communication between the AP and one or more non-AP STAs in the wireless communication frequency channel, e.g., as described below.

In some demonstrative aspects, controller 124 may be configured to control, trigger, cause, and/or instruct the AP implemented by device 102 to identify the AP-blocked frequency BW, for example, based on an identified interference from a memory of the platform including the AP, e.g., as described below.

In other aspects, controller 124 may be configured to control, trigger, cause, and/or instruct the AP implemented by device 102 to identify the AP-blocked frequency BW based on an identified interference from any other additional or alternative components of the platform including the AP.

In some demonstrative aspects, controller 124 may be configured to control, trigger, cause, and/or instruct the AP implemented by device 102 to identify the AP-blocked frequency BW, for example, based on one or more real-time operation parameters of the one or more platform components of the platform including the AP, e.g., as described below.

In some demonstrative aspects, controller 124 may be configured to control, trigger, cause, and/or instruct the AP implemented by device 102 to identify the AP-blocked frequency BW, for example, based on an identified performance degradation over the AP-blocked frequency BW, e.g., as described below.

In some demonstrative aspects, controller 124 may be configured to control, trigger, cause, and/or instruct the AP implemented by device 102 to identify the AP-blocked frequency BW, for example, based on an identified RFI over the AP-blocked frequency BW, e.g., as described below.

In other aspects, controller 124 may be configured to control, trigger, cause, and/or instruct the AP implemented by device 102 to identify the AP-blocked frequency BW based on any other additional and/or alternative criteria and/or parameters.

In some demonstrative aspects, device 102, device 140, and/or device 160 may be configured to implement one or more operations and/or functionalities of a frequency BW blocking mechanism, which may be configured to block one or more blocked frequency BWs in a wireless communication frequency channel, for example, based on an identified interference over a blocked frequency BW, e.g., as described below.

In some demonstrative aspects, a STA, e.g., an AP implemented by device 102 and/or a non-AP STA implemented by device 140, may be configured to implement an interference measurement mechanism, for example, to determine the identified interference of one or more components of a platform including the STA, e.g., as described below.

In some demonstrative aspects, the interference measurement mechanism may include an offline interference measurement, which may be performed, for example, offline, e.g., as described below.

For example, the offline interference measurement may include platform interference measurements performed and/or characterized offline, for example, using a Noise Diagnostic Tool (NDT), and/or any other suitable technique.

In another example, offline platform interference measurements may be performed, for example, by placing a platform under test in a shield box, e.g., which may shield the platform under test from receiving over-the-air signals; operating the platform under test to receive and measure signals, e.g., without being connected to an AP; and executing one or more workloads on the platform under test, while performing measurements of the platform interference corresponding to the workloads.

In some demonstrative aspects, the interference measurement mechanism may include a real-time interference measurement, which may be performed, for example, during Wi-Fi operation, e.g., as described below.

In some demonstrative aspects, the offline interference measurements may be utilized to identify different interferences across a frequency BW of a wireless communication channel. For example, the NDT may be used to measure a spectrum of the wireless communication channel, e.g., a 40 MHz channel and/or any other channel.

For example, noise may vary across a band, for example, where narrowband noises may impact performance of a platform in that band. According to this example, the platform may, e.g., will, greatly benefit of using the frequency BW blocking mechanism.

For example, NDT data may be combined and/or polished by in-lab measurements, for example, using a spectrum analyzer and/or any other similar lab equipment.

For example, the NDT data may be used, for example, to measure Wi-Fi de-sense values.

For example, measured Wi-Fi de-sense values may be utilized for characterization of platform-specific noise and/or interference data. For example, a compressed form of the measured Wi-Fi de-sense values may be stored on a pre-defined storage at a platform, for example, to be read during run-time.

In some demonstrative aspects, a STA, e.g., an AP implemented by device 102 and/or a non-AP STA implemented by device 140, may be configured to identify a frequency BW to be blocked, for example, based on measured noise and/or interference of communications over the frequency BW, e.g., as described below.

For example, the STA may utilize Wi-Fi firmware to measure RF noise and/or interference between packets, for example, to detect non-Wi-Fi interference.

In some demonstrative aspects, run-time interference maybe identified and/or characterized, for example, based on offline and/or run-time interference data, which may be combined, for example, with statistics and/or indicators from a DDR on memory load, statistics and/or indicators from high-speed I/O, and/or statistics and/or indicators from any other additional or alternative platform components.

In some demonstrative aspects, device 102, device 140, and/or device 160 may be configured to implement one or more operations and/or functionalities of an interference measurement mechanism, which may support evaluation of a platform interference against a Wi-Fi operating channel, for example, during run-time, e.g., as described below.

For example, platform interference, which may vary per model and/or design of a platform, may be characterized pre-production, for example, using the NDT, e.g., as described above. According to this example, the platform-specific data may be stored on the platform, e.g., in a dedicated memory location.

In some demonstrative aspects, a STA implemented by the platform, e.g., an AP implemented by device 102 and/or a non-AP STA implemented by device 140, may be configured to evaluate a strength and/or location of a potential interference against the Wi-Fi operating channel, for example, based on a workload and/or utilization of a DDR and/or any other interference generating component of the platform.

In some demonstrative aspects, the STA, e.g., the AP implemented by device 102 and/or the non-AP STA implemented by device 140, may be configured to identify which parts of the Wi-Fi operating channel are susceptible to performance degradation, for example, due to the platform interference, e.g., as described below.

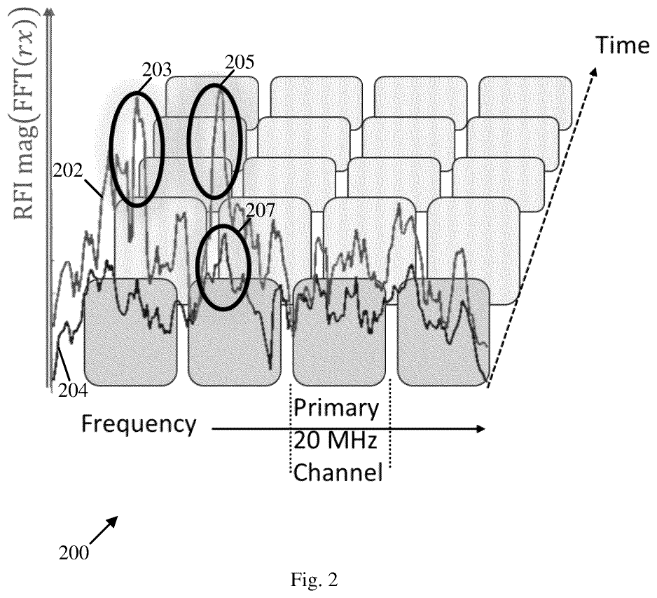

Reference is made to FIG. 2, which schematically illustrates interference measurements 200 for two different workloads, in accordance with some demonstrative aspects.

For example, a STA, e.g., an AP implemented by device 102 (FIG. 1) and/or a non-AP STA implemented by device 140 (FIG. 1), may be configured to determine an RFI for two different workloads.

For example, as shown in FIG. 2, the STA, e.g., the AP implemented by device 102 (FIG. 1) and/or the non-AP STA implemented by device 140 (FIG. 1), may determine an RFI for a workload 202 and a workload 204, for example, in an 80 MHz channel.

For example, workload 202 may include a memory intensive workload, e.g., video editing and/or any other memory intensive workload.

For example, workload 204 may include a less intensive workload, e.g., a background email update.

For example, the STA, e.g., the AP implemented by device 102 (FIG. 1) and/or the non-AP STA implemented by device 140 (FIG. 1), may obtain information on a workload, for example, from platform indicators and/or applications running on the platform.

For example, as shown in FIG. 2, the STA, e.g., the AP implemented by device 102 (FIG. 1) and/or the non-AP STA implemented by device 140 (FIG. 1), may identify RUs that are susceptible to interference, for example, as shown by circle 203, circle 205, and/or circle 207.

In one example, the STA, e.g., the AP implemented by device 102 (FIG. 1) and/or the non-AP STA implemented by device 140 (FIG. 1), may ignore the presence of a weak interference, e.g., as shown by circle 207, for example, based on values of an operating Signal-to-Noise Ratio (SNR).

In another example, the STA may even take into consideration the weak interference shown by circle 207, for example, based on a determination that the STA is distanced from an AP and SNR is relatively low.

Referring back to FIG. 1, in some demonstrative aspects, device 102, device 140, and/or device 160 may be configured to implement one or more operations and/or functionalities of a negotiation mechanism, which may be configured to support negotiating between a non-AP STA and an AP which part of a band is to be blocked, for example, to improve overall network performance, e.g., as described below.

In some demonstrative aspects, the negotiation mechanism may be configured to support an information exchange between the non-AP STA and the AP, for example, to block a frequency blocked BW, for example, to block use of one or more RUs that are identified as “susceptible” to interference, e.g., as described below.

For example, a STA, e.g., a non-AP STA implemented by device 140, may communicate with an AP a request to block one or more interfering RUs for resource allocation and/or data exchange, for example, once locations of the interfering RUs are identified.

In some demonstrative aspects, the information exchange may include a punctured channel information exchange, e.g., in compliance with the IEEE 802.11be Specification. For example, it may be defined that, in case of in-device self-interference, a per-STA puncturing may be performed, e.g., dynamically, for example, in a Transmit Opportunity (TxOP) basis per STA. For example, in a downlink MU-OFDMA transmission, an AP may avoid scheduling per STA-based on one or more RUs impacted by platform noise.

In some demonstrative aspects, the information exchange may include a parameter update information exchange, e.g., in compliance with an IEEE 802.11 Specification.

For example, a non-AP STA, e.g., the non-AP STA implemented by device 140, and an AP, e.g., the AP implemented by device 102, may be configured to implement one or more operations and/or functionalities of a parameter update mechanism, which may support updating one or more Transmit (Tx)/Receive (Rx) (Tx/Rx) parameters, for example, based on management level signaling that allows the non-AP STA to transition in/out of a limited operation/capability mode, e.g., in compliance with the IEEE 802.11 Specification.

For example, a STA operating in a limited operation/capability mode may be allowed to update one or more Tx/Rx parameters, for example, including a maximum PPDU duration, a maximum MCS, use of a Low Density Parity Check (LDPC), use of an HT-immediate Block acknowledgement (BlockAck), a disabled sub-channel bitmap, and/or any other additional or alternative Tx/Rx parameters.

In some demonstrative aspects, it may be defined that the list of blocked RUs is to be included in the parameters, which may be supported by the parameter update mechanism.

In some demonstrative aspects, the parameter update mechanism may be configured to support a non-AP STA to send to an AP a list of blocked RUs, for example, to identify one or more RUs, which the AP is requested to block for the non-AP STA, e.g., as described above.

In some demonstrative aspects, device 102, device 140, and/or device 160 may be configured to implement one or more operations and/or functionalities of a signaling mechanism, which may be configured to support signaling of a blocked frequency BW, e.g., as described below.

In some demonstrative aspects, the signaling mechanism may be configured to support signaling an indication of an RU allocation of a blocked RU, for example, one RU, e.g., a 26-tone RU, a 52-tone RU, and/or an RU of any other size, that contains interference.

In some demonstrative aspects, it may be defined, for example, that one or more, e.g., all, RUs of any other sizes, which would overlap with the blocked RU should also be blocked.

In some demonstrative aspects, the signaling mechanism may be configured to support signaling of one or more blocked RUs, for example, in a blocked-RU field.

In some demonstrative aspects, the blocked-RU field may be included, for example, in an HE Signal (SIG) B field (HE-SIG-B).

In some demonstrative aspects, it may be defined that the blocked-RU field may be interpreted, for example, as a list of “Blocked RUs”.

In one example, the list of blocked RUs may be encoded for example, using a coding mechanism similar to a coding mechanism for signaling allocated RUs, e.g., in accordance with an IEEE 802.11 Standard.

In some demonstrative aspects, the signaling mechanism may be configured to utilize a bitmap including a plurality of bits corresponding to a plurality of RUs. According to this example, a bit value of a bit may indicate whether or not an RU corresponding to the bit is to be blocked.

In some demonstrative aspects, the signaling mechanism may be configured to support signaling a center frequency and/or an interference BW, for example, to describe an area to be blocked.

In some demonstrative aspects, the interference BW may be defined, for example, to support a desired BW granularity, e.g., 1 MHz, 2 MHz, and/or any other additional or alternative BW.

In one example, the signaling mechanism may be configured to reuse a report element, for example, a Co-located Interference Report element, to describe the area to be blocked. In another example, the signaling mechanism may be configured to use any other additional or alternative element to describe the area to be blocked.

In some demonstrative aspects, device 102, device 140, and/or device 160 may be configured to implement one or more operations and/or functionalities of a frequency BW blocking mechanism, e.g., as described above, for example, to provide a technical solution to support mapping out where a platform interference may degrade Wi-Fi performance, e.g., for a given channel of operation, for example, during run-time.

For example, the platform interference may be workload dependent and/or may vary from one platform design to another.

In some demonstrative aspects, device 102, device 140, and/or device 160 may be configured to implement one or more operations and/or functionalities of an interference measurement mechanism, which may be configured to support identifying a strength and/or a location of the platform interference, e.g., as described above.

In some demonstrative aspects, device 102, device 140, and/or device 160 may be configured to identify a type of workload, which may, e.g., would, determine an optimized memory speed.

For example, a STA, e.g., a non-AP STA implemented by device 140, may be configured to identify one or more frequency BWs susceptible to interference, e.g., as described above.

For example, the STA may send a request to an AP to block the identified frequency BWs for data exchange for example, in a granularity of RU sizes, e.g., as described above.

In some demonstrative aspects, it may be defined that the STA may send to the AP a block request to indicate one or more STA-blocked RUs, which are to be blocked for communication between the AP and the non-AP STA, e.g., as described above.

In some demonstrative aspects, it may be defined that the AP may not, e.g., shall not, transmit on the STA-blocked RUs, which are identified by the request from the STA.

In example, it may be defined that the AP is to block the STA-blocked RUs identified by the STA, for example, by puncturing for the STA one or more overlapping 20 MHz, which have an overlap with the one or more STA-blocked RUs. For example, the AP may apply this STA-specific puncturing, e.g., for transmission of a SU PPDU to the STA.

In another example, it may be defined that the AP is to select not to schedule the STA with RUs overlapping with the blocked area including the STA-blocked RUs. For example, the AP may apply this STA-specific RU scheduling, e.g., for MU operation.

In some demonstrative aspects, device 102, device 140, and/or device 160 may be configured to implement one or more operations and/or functionalities of a frequency BW blocking mechanism, which may be configured to provide a technical solution to improve Wi-Fi performance, e.g., as described below.

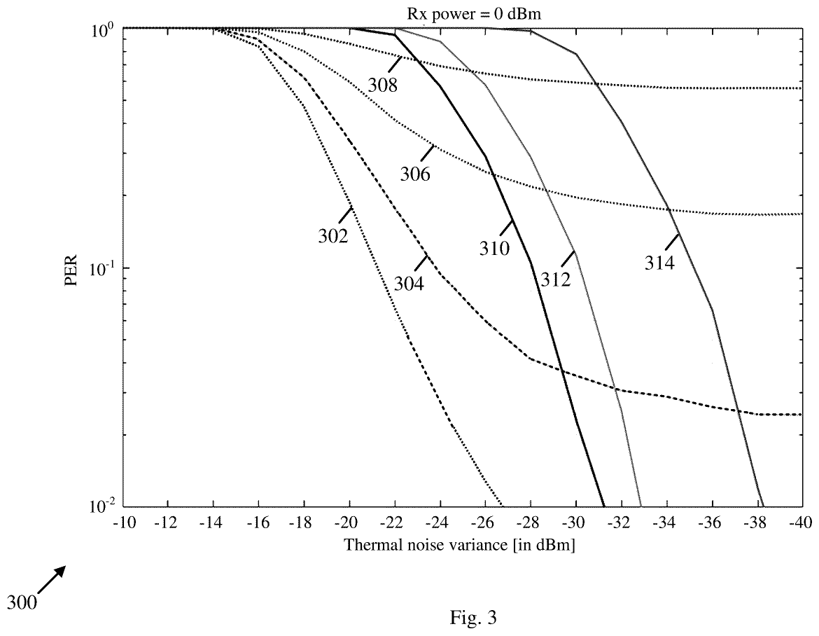

Reference is made to FIG. 3, which schematically illustrates simulation results 300 of Packet Error Ratio (PER) versus thermal noise variance for simulated data transmissions, in accordance with some demonstrative aspects.

For example, simulation results 300 may include PER curves for cases of non-blocked RUs, which are not susceptible to noise and/or interference, and PER curves for cases of blocked RUs susceptible to noise and/or interference.

For example, simulation results 300 may demonstrate benefits of blocking one or more RUs susceptible to interference, for example, in presence of large platform RFI noise.

For example, as shown in FIG. 3, simulation results 300 may include simulation results for data transmission over a 40 MHz bandwidth, of which 20 MHz, e.g., nine RUs, may be susceptible to relatively large platform RFI noise.

For example, the simulation results 300 may be based on a setup of an Rx power fixed at 0 decibel-milliwatts (dBm).

For example, the simulation results 300 may be based on a setup of a platform noise, which may vary from −14 dBm to −22 dBm, for example, over nine RUs.

For example, as shown in FIG. 3, simulation results 300 depict PER curves for thermal additive noise from −10 dBm to −40 dBm.

For example, as shown in FIG. 3, a first set of PER curves, which includes a curve 302, a curve 304, a curve 306, and a curve 308, may correspond to data transmission over an entire 40 MHz band using an appropriate MCS scheme, e.g., without blocking any RUs.

For example, the PER curves 302, 304, 306 and 308 may correspond to data transmission of packets over the entire band using an MCS with an MCS index MCS3 (16QAM).

For example, curve 302 may correspond to a measured RFI noise of −20 dBm, and the MCS index MCS3, e.g., a 16QAM scheme with a coding rate of 1/2.

For example, curve 304 may correspond to a measured RFI noise of −18 dBm, and the MCS index MCS3, e.g., a 16QAM scheme with a coding rate of 1/2.

For example, curve 306 may correspond to a measured RFI noise of −16 dBm, and the MCS index MCS3, e.g., a 16QAM scheme with a coding rate of 1/2.

For example, curve 308 may correspond to a measured RFI noise of −14 dBm, and the MCS index MCS3, e.g., a 16QAM scheme with a coding rate of 1/2.

For example, as shown in FIG. 3, a second set of curves, which includes a curve 310, a curve 312, and a curve 314, may correspond to data transmission when all nine noisy RUs are blocked, e.g., no data is sent on a highly noisy 20 MHz band including the nine noisy RUs.

For example, an MCS scheme for the remaining 20 MHz band, e.g., excluding the blocked 20 MHz band, may be chosen such that the throughput is at least equal to the throughput of the case without any RU blocking.

For example, curve 310 may correspond to the MCS index MCS5, e.g., a 64QAM scheme with a coding rate 2/3.

For example, curve 312 may correspond to the MCS index MCS6, e.g., a 64QAM scheme with a coding rate 3/4.

For example, curve 314 may correspond to the MCS index MCS8, e.g., a 256QAM scheme with a coding rate 3/4.

For example, as shown in FIG. 3, sensitivity for the blocked-RU case, as represented by curves 310, 312 and 314, may surpass the no-blocking case, as represented by the curves 302, 304, 306, and 308, for example, when the platform noise level is greater than −18 dBm.

For example, as shown in FIG. 3, even at lower RFI noise levels, the blocked-RU case may, e.g., will always, outperform the no-blocking case, for example, at some SNR.

For example, as shown in FIG. 3, the lowest MCS, e.g., the MCS index MCS5, for the blocked-RU case, e.g., as represented by the PER curve 310, may provide substantially the same throughput as the no-blocking case, e.g., as represented by the PER curves 302, 304, 306 and 308.

For example, as shown in FIG. 3, the other PER curves corresponding to the blocked-RU case, e.g., curves 312 and 314, may have higher throughput than the no-blocking case, e.g., as represented by the PER curves 302, 304, 306 and 308, e.g., without including a preamble overhead, which may, e.g., would, be higher for the higher MCS cases of the blocked-RUs case.

For example, as shown in FIG. 3, the throughput for the blocked-RU case may be 1, 1.125, and 1.5 times the throughput of the no-blocking case for the MCS indexes 5, 6, and 8, respectively.

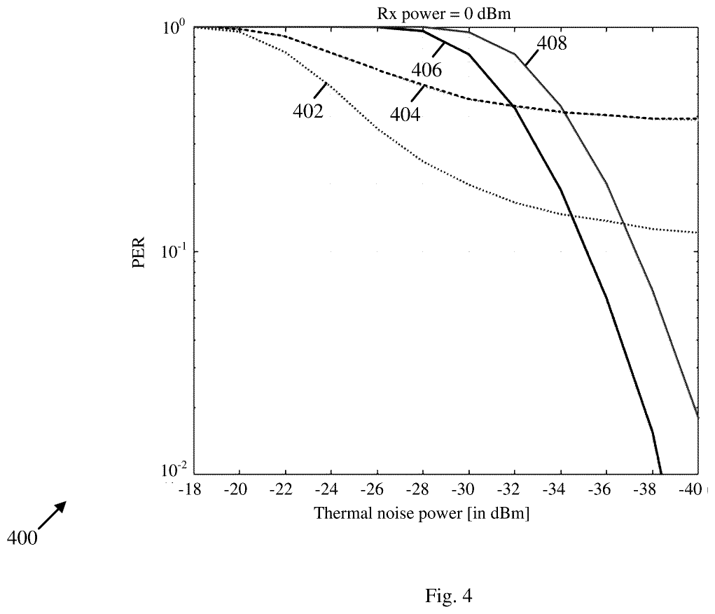

Reference is made to FIG. 4, which schematically simulation results 400 of PER versus thermal noise power for simulated data transmissions, in accordance with some demonstrative aspects.

For example, simulation results 400 may include PER curves for cases of non-blocked RUs, which are not susceptible to noise and/or interference, and PER curves for cases of blocked RUs susceptible to noise and/or interference.

For example, simulation results 400 may demonstrate benefits of blocking one or more RUs susceptible to interference, for example, in presence of large platform RFI noise.

For example, as shown in FIG. 4, simulation results 400 may include simulation results for data transmission over a 40 MHz bandwidth, of which 20 MHz, e.g., nine RUs, may be susceptible to relatively large platform RFI noise.

For example, the simulation results 400 may be based on a setup of an Rx power fixed at 0 dBm.

For example, the simulation results 400 may be based on a setup of a platform noise, which may vary from −20 dBm to −22 dBm, for example, over nine RUs.

For example, as shown in FIG. 4, simulation results 400 depict PER curves for thermal additive noise from −18 dBm to −40 dBm.

For example, as shown in FIG. 4, a first set of PER curves, which includes a curve 402 and a curve 404, may correspond to data transmission over an entire 40 MHz band using an appropriate MCS scheme, e.g., without blocking any RUs.

For example, the PER curve 402 and the PER curve 404 may correspond to data transmission of packets over the entire 40 Mhz band using an MCS with an MCS index MCS4 (16QAM).

For example, curve 402 may correspond to a measured RFI noise of −22 dBm, and the MCS index MCS4, e.g., a 16QAM scheme with a coding rate 3/4.

For example, curve 404 may correspond to a measured RFI noise of −20 dBm, and the MCS index MCS4, e.g., a 16QAM scheme with a coding rate 3/4.

For example, as shown in FIG. 4, a second set of curves, which includes a curve 406 and a curve 408, may correspond to data transmission when all nine noisy RUs are blocked, e.g., no data is sent on a highly noisy 20 MHz band including the nine noisy RUs.

For example, an MCS scheme for the remaining 20 MHz band, e.g., excluding the blocked 20 MHz band, may be chosen such that the throughput is at least equal to the throughput of the case without any RU blocking.

For example, curve 406 may correspond to the MCS index MCS8, e.g., a 256QAM scheme with a coding rate 3/4.

For example, curve 406 may correspond to the MCS index MCS9, e.g., a 256QAM scheme with a coding rate 5/6).

For example, as shown in FIG. 4, throughput for the blocked-RU case is 1, and 1.11 times the no-blocking case for MCS indexes 8 and 9, respectively.

In some demonstrative aspects, as shown in FIG. 3 and FIG. 4, blocking noisy RUs and transmitting at a higher MCS, for example, when platform noise is high, may provide a technical solution to improve sensitivity, PER, and/or throughput.

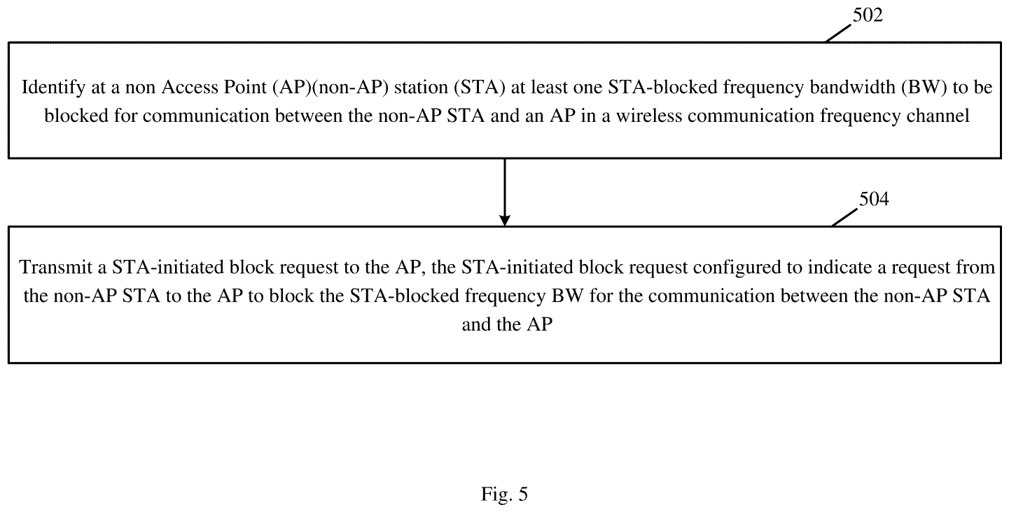

Reference is made to FIG. 5, which schematically illustrates a method of frequency BW blocking for wireless communication, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include identifying, at a non-AP STA, at least one STA-blocked frequency BW to be blocked for communication between the non-AP STA and an AP in a wireless communication frequency channel. For example, controller 154 (FIG. 1) may be configured to cause, trigger, and/or control a non-AP STA implemented by device 140 (FIG. 1) to identify at least one STA-blocked frequency BW to be blocked for communication between the non-AP STA and an AP in a wireless communication frequency channel, e.g., as described above.

As indicated at block 504, the method may include transmitting a STA-initiated block request to the AP. For example, the STA-initiated block request may be configured to indicate a request from the non-AP STA to the AP to block the STA-blocked frequency BW for the communication between the non-AP STA and the AP. For example, controller 154 (FIG. 1) may be configured to cause, trigger, and/or control the non-AP STA implemented by device 140 (FIG. 1) to transmit a STA-initiated block request to the AP, e.g., as described above.

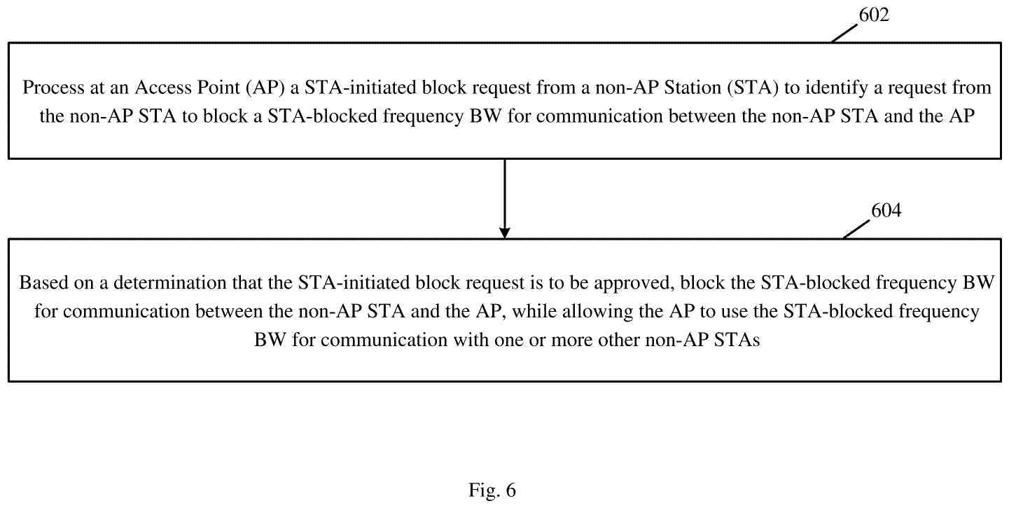

Reference is made to FIG. 6, which schematically illustrates a method of frequency BW blocking for wireless communication, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include processing, at an AP, a STA-initiated block request from a non-AP STA to identify a request from the non-AP STA to block a STA-blocked frequency BW for communication between the non-AP STA and the AP. For example, controller 124 (FIG. 1) may be configured to cause, trigger, and/or control an AP implemented by device 102 (FIG. 1) to process a STA-initiated block request from a non-AP STA to identify a request from the non-AP STA to block a STA-blocked frequency BW for communication between the non-AP STA and the AP, e.g., as described above.

As indicated at block 604, the method may include blocking the STA-blocked frequency BW for communication between the non-AP STA and the AP, for example, while allowing the AP to use the STA-blocked frequency BW for communication with one or more other non-AP STAs, for example, based on a determination that the STA-initiated block request is to be approved. For example, controller 124 (FIG. 1) may be configured to cause, trigger, and/or control the AP implemented by device 102 (FIG. 1) to block the STA-blocked frequency BW for communication between the non-AP STA and the AP, for example, while allowing the AP to use the STA-blocked frequency BW for communication with one or more other non-AP STAs, e.g., as described above.

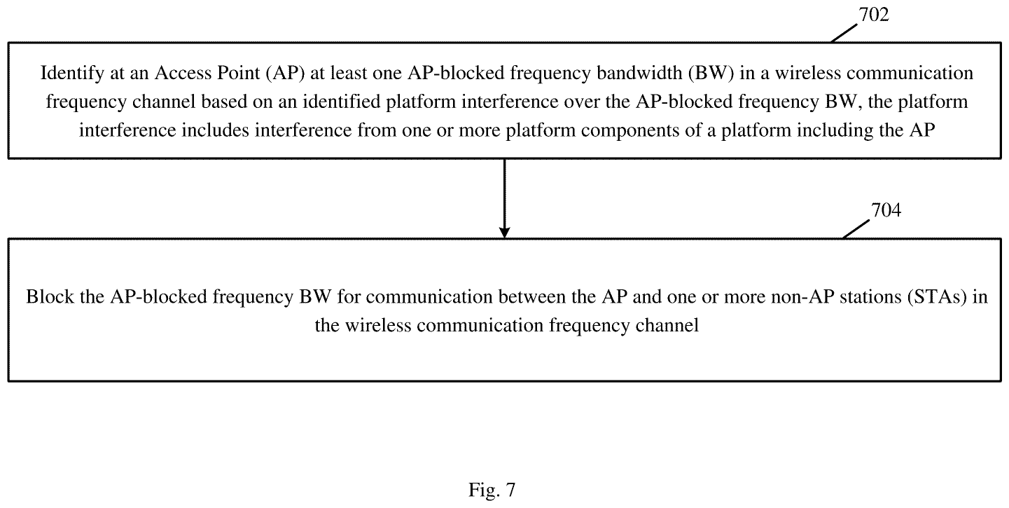

Reference is made to FIG. 7, which schematically illustrates a method of frequency BW blocking for wireless communication, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include identifying, at an AP, at least one AP-blocked frequency BW in a wireless communication frequency channel, for example, based on an identified platform interference over the AP-blocked frequency BW. For example, the platform interference may include interference from one or more platform components of a platform including the AP. For example, controller 124 (FIG. 1) may be configured to cause, trigger, and/or control an AP implemented by device 102 (FIG. 1) to identify at least one AP-blocked frequency BW in a wireless communication frequency channel, for example, based on an identified platform interference over the AP-blocked frequency BW, e.g., as described above.

As indicated at block 704, the method may include blocking the AP-blocked frequency BW for communication between the AP and one or more non-AP STAs in the wireless communication frequency channel. For example, controller 124 (FIG. 1) may be configured to cause, trigger, and/or control the AP implemented by device 102 (FIG. 1) to block the AP-blocked frequency BW for communication between device 102 (FIG. 1) and one or more non-AP STAs in the wireless communication frequency channel, e.g., as described above.

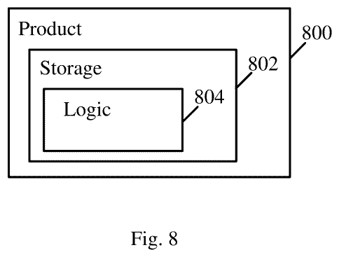

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 an apparatus comprising logic and circuitry configured to cause a non Access Point (AP) (non-AP) station (STA) to identify at least one STA-blocked frequency bandwidth (BW) to be blocked for communication between the non-AP STA and an AP in a wireless communication frequency channel; and transmit a STA-initiated block request to the AP, the STA-initiated block request configured to indicate a request from the non-AP STA to the AP to block the STA-blocked frequency BW for the communication between the non-AP STA and the AP.

Example 2 includes the subject matter of Example 1, and optionally, wherein the apparatus is configured to cause the non-AP STA to process a response from the AP to identify whether or not the STA-initiated block request is approved by the AP.

Example 3 includes the subject matter of Example 1 or 2, and optionally, wherein the STA-initiated block request comprises a duration field to indicate a duration for blocking the STA-blocked frequency BW for the non-AP STA.

Example 4 includes the subject matter of any one of Examples 1-3, and optionally, wherein the apparatus is configured to cause the non-AP STA to transmit a termination message to request the AP to terminate blocking of the STA-blocked frequency BW for the non-AP STA.

Example 5 includes the subject matter of any one of Examples 1-4, and optionally, wherein the STA-initiated block request comprises a STA-initiated puncturing request to request the AP to puncture the STA-blocked frequency BW for the STA.

Example 6 includes the subject matter of any one of Examples 1-6, and optionally, wherein the apparatus is configured to cause the non-AP STA to transmit the STA-initiated block request in a parameter update request comprising one or more parameters to be updated according to an operation mode of the non-AP STA.

Example 7 includes the subject matter of any one of Examples 1-6, and optionally, wherein the STA-initiated block request comprises an indication of a STA-blocked Resource Unit (RU), which comprises the STA-blocked frequency BW.

Example 8 includes the subject matter of Example 7, and optionally, wherein the STA-initiated block request is configured to indicate to the AP a request to block the STA-blocked RU and any RU having an overlap with the STA-blocked RU.

Example 9 includes the subject matter of Example 7 or 8, and optionally, wherein the STA-initiated block request comprises a bitmap including a plurality of bits corresponding to a plurality of RUs, wherein a bit value of a bit is to indicate whether or not an RU corresponding to the bit is to be blocked for the non-AP STA.

Example 10 includes the subject matter of any one of Examples 1-9, and optionally, wherein the STA-initiated block request comprises a center-frequency value to indicate a center frequency of the STA-blocked frequency BW, and a BW value to indicate a BW of the STA-blocked frequency BW.

Example 11 includes the subject matter of any one of Examples 1-10, and optionally, wherein the STA-initiated block request comprises a blocked Resource Unit (RU) field comprising a predefined RU-set value selected from a plurality of predefined RU-set values mapped to a plurality of predefined RU sets, respectively, wherein the predefined RU-set value is to indicate a set of one or more RUs having an overlap with the STA-blocked frequency BW.

Example 12 includes the subject matter of any one of Examples 1-11, and optionally, wherein the STA-initiated block request is configured to indicate a request from the non-AP STA to the AP to block the STA-blocked frequency BW for any data transmission from the AP to the non-AP STA.

Example 13 includes the subject matter of any one of Examples 1-12, and optionally, wherein the STA-initiated block request is configured to indicate a request from the non-AP STA to the AP to block the STA-blocked frequency BW for any Resource Unit (RU) allocation to be provided by the AP to the non-AP STA.

Example 14 includes the subject matter of any one of Examples 1-13, and optionally, wherein the apparatus is configured to cause the non-AP STA to identify the STA-blocked frequency BW based on an identified interference over the STA-blocked frequency BW.

Example 15 includes the subject matter of any one of Examples 1-14, and optionally, wherein the apparatus is configured to cause the non-AP STA to identify the STA-blocked frequency BW based on an identified platform interference over the STA-blocked frequency BW, the identified platform interference comprises interference from one or more platform components of a platform comprising the non-AP STA.

Example 16 includes the subject matter of any one of Examples 1-15, and optionally, wherein the apparatus is configured to cause the non-AP STA to identify the STA-blocked frequency BW based on an identified interference from a memory of a platform comprising the non-AP STA.

Example 17 includes the subject matter of any one of Examples 1-16, and optionally, wherein the apparatus is configured to cause the non-AP STA to identify the STA-blocked frequency BW based on one or more real-time operation parameters of one or more platform components of a platform comprising the non-AP STA.

Example 18 includes the subject matter of any one of Examples 1-17, and optionally, wherein the apparatus is configured to cause the non-AP STA to identify the STA-blocked frequency BW based on an identified performance degradation over the STA-blocked frequency BW.

Example 19 includes the subject matter of any one of Examples 1-18, and optionally, wherein the apparatus is configured to cause the non-AP STA to identify the STA-blocked frequency BW based on an identified Radio-Frequency Interference (RFI) over the STA-blocked frequency BW.

Example 20 includes the subject matter of any one of Examples 1-19, and optionally, comprising a radio to transmit the STA-initiated block request to the AP.

Example 21 includes the subject matter of Example 20, and optionally, comprising one or more antennas connected to the radio, and a processor to execute instructions of an operating system.

Example 22 includes an apparatus comprising logic and circuitry configured to cause an Access Point (AP) to process a STA-initiated block request from a non-AP Station (STA) to identify a request from the non-AP STA to block a STA-blocked frequency BW for communication between the non-AP STA and the AP; and, based on a determination that the STA-initiated block request is to be approved, block the STA-blocked frequency BW for communication between the non-AP STA and the AP, while allowing the AP to use the STA-blocked frequency BW for communication with one or more other non-AP STAs.

Example 23 includes the subject matter of Example 22, and optionally, wherein the apparatus is configured to cause the AP to transmit a response to the non-AP STA to indicate to the non-AP STA whether or not the STA-initiated block request is approved by the AP.

Example 24 includes the subject matter of Example 22 or 23, and optionally, wherein the apparatus is configured to cause the AP to process a duration field in the STA-initiated block request to identify a duration for blocking the STA-blocked frequency BW for the non-AP STA.

Example 25 includes the subject matter of any one of Examples 22-24, and optionally, wherein the apparatus is configured to cause the AP to process a termination message from the non-AP STA to identify a request from the non-AP STA to terminate blocking of the STA-blocked frequency BW for the non-AP STA.

Example 26 includes the subject matter of any one of Examples 22-25, and optionally, wherein the STA-initiated block request comprises a STA-initiated puncturing request to request the AP to puncture the STA-blocked frequency BW for the non-AP STA.

Example 27 includes the subject matter of any one of Examples 22-26, and optionally, wherein the apparatus is configured to cause the AP to process a parameter update request to identify the STA-initiated block request, the parameter update request comprising one or more parameters to be updated according to an operation mode of the non-AP STA.

Example 28 includes the subject matter of any one of Examples 22-27, and optionally, wherein the STA-initiated block request comprises an indication of a STA-blocked Resource Unit (RU), which comprises the STA-blocked frequency BW.

Example 29 includes the subject matter of Example 28, and optionally, wherein the apparatus is configured to cause the AP to determine that any RU having an overlap with the STA-blocked RU is to be blocked for communication between the non-AP STA and the AP.

Example 30 includes the subject matter of Example 28 or 29, and optionally, wherein the STA-initiated block request comprises a bitmap including a plurality of bits corresponding to a plurality of RUs, wherein a bit value of a bit is to indicate whether or not an RU corresponding to the bit is to be blocked for the non-AP STA.

Example 31 includes the subject matter of any one of Examples 22-30, and optionally, wherein the STA-initiated block request comprises a center-frequency value to indicate a center frequency of the STA-blocked frequency BW, and a BW value to indicate a BW of the STA-blocked frequency BW.

Example 32 includes the subject matter of any one of Examples 22-31, and optionally, wherein the STA-initiated block request comprises a blocked Resource Unit (RU) field comprising a predefined RU-set value selected from a plurality of predefined RU-set values mapped to a plurality of predefined RU sets, respectively, wherein the predefined RU-set value is to indicate a set of one or more RUs having an overlap with the STA-blocked frequency BW.

Example 33 includes the subject matter of any one of Examples 22-32, and optionally, wherein the apparatus is configured to cause the AP to determine, based on the STA-initiated block request, to block the STA-blocked frequency BW for any data transmission from the AP to the non-AP STA.

Example 34 includes the subject matter of any one of Examples 22-33, and optionally, wherein the apparatus is configured to cause the AP to determine, based on the STA-initiated block request, to block the STA-blocked frequency BW for any Resource Unit (RU) allocation to be provided by the AP to the non-AP STA.

Example 35 includes the subject matter of any one of Examples 22-34, and optionally, wherein the apparatus is configured to cause the AP to identify a first request from a first non-AP STA to block a first STA-blocked frequency BW for communication between the first non-AP STA and the AP; identify a second request from a second non-AP STA to block a second STA-blocked frequency BW for communication between the second non-AP STA and the AP, wherein the second STA-blocked frequency BW is different from the first STA-blocked frequency BW; block the first STA-blocked frequency BW for communication between the first non-AP STA and the AP, while allowing the AP to use the first STA-blocked frequency BW for communication with the second non-AP STA; and block the second STA-blocked frequency BW for communication between the second non-AP STA and the AP, while allowing the AP to use the second STA-blocked frequency BW for communication with the first non-AP STA.

Example 36 includes the subject matter of any one of Examples 22-35, and optionally, comprising a radio to receive the STA-initiated block request from the non-AP STA.

Example 37 includes the subject matter of Example 36, and optionally, comprising one or more antennas connected to the radio, and a processor to execute instructions of an operating system.

Example 38 includes an apparatus comprising logic and circuitry configured to cause an Access Point (AP) to identify at least one AP-blocked frequency bandwidth (BW) in a wireless communication frequency channel based on an identified platform interference over the AP-blocked frequency BW, the platform interference comprises interference from one or more platform components of a platform comprising the AP; and block the AP-blocked frequency BW for communication between the AP and one or more non-AP stations (STAs) in the wireless communication frequency channel.

Example 39 includes the subject matter of Example 38, and optionally, wherein the apparatus is configured to cause the AP to identify the AP-blocked frequency BW based on an identified interference from a memory of the platform comprising the AP.

Example 40 includes the subject matter of Example 38 or 39, and optionally, wherein the apparatus is configured to cause the AP to identify the AP-blocked frequency BW based on one or more real-time operation parameters of the one or more platform components of the platform comprising the AP.

Example 41 includes the subject matter of any one of Examples 38-40, and optionally, wherein the apparatus is configured to cause the AP to identify the AP-blocked frequency BW based on an identified performance degradation over the AP-blocked frequency BW.

Example 42 includes the subject matter of any one of Examples 38-41, and optionally, wherein the apparatus is configured to cause the AP to identify the AP-blocked frequency BW based on an identified Radio-Frequency Interference (RFI) over the AP-blocked frequency BW.

Example 43 includes the subject matter of any one of Examples 38-42, and optionally, comprising a radio to communicate over the wireless communication frequency channel.

Example 44 includes the subject matter of Example 43, and optionally, comprising one or more antennas connected to the radio, and a processor to execute instructions of an operating system.

Example 45 comprises a wireless communication device comprising the apparatus of any of Examples 1-44.

Example 46 comprises a mobile device comprising the apparatus of any of Examples 1-44.

Example 47 comprises an apparatus comprising means for executing any of the described operations of any of Examples 1-44.

Example 48 comprises a product comprising one or more tangible computer-readable non-transitory storage media comprising instructions operable to, when executed by at least one processor, enable the at least one processor to cause a wireless communication device to perform any of the described operations of any of Examples 1-44.

Example 49 comprises an apparatus comprising: a memory interface; and processing circuitry configured to: perform any of the described operations of any of Examples 1-44.

Example 50 comprises a method comprising any of the described operations of any of Examples 1-44.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a non Access Point (AP) (non-AP) station (STA) to:
identify at least one STA-blocked frequency bandwidth (BW) to be blocked for communication between the non-AP STA and an AP in a wireless communication frequency channel; and
transmit a STA-initiated block request to the AP, the STA-initiated block request configured to indicate a request from the non-AP STA to the AP to block the STA-blocked frequency BW for the communication between the non-AP STA and the AP.

2. The apparatus of claim 1 configured to cause the non-AP STA to process a response from the AP to identify whether or not the STA-initiated block request is approved by the AP.

3. The apparatus of claim 1, wherein the STA-initiated block request comprises a duration field to indicate a duration for blocking the STA-blocked frequency BW for the non-AP STA.

4. The apparatus of claim 1 configured to cause the non-AP STA to transmit a termination message to request the AP to terminate blocking of the STA-blocked frequency BW for the non-AP STA.

5. The apparatus of claim 1, wherein the STA-initiated block request comprises a STA-initiated puncturing request to request the AP to puncture the STA-blocked frequency BW for the STA.

6. The apparatus of claim 1 configured to cause the non-AP STA to transmit the STA-initiated block request in a parameter update request comprising one or more parameters to be updated according to an operation mode of the non-AP STA.

7. The apparatus of claim 1, wherein the STA-initiated block request comprises an indication of a STA-blocked Resource Unit (RU), which comprises the STA-blocked frequency BW.

8. The apparatus of claim 7, wherein the STA-initiated block request is configured to indicate to the AP a request to block the STA-blocked RU and any RU having an overlap with the STA-blocked RU.

9. The apparatus of claim 7, wherein the STA-initiated block request comprises a bitmap including a plurality of bits corresponding to a plurality of RUs, wherein a bit value of a bit is to indicate whether or not an RU corresponding to the bit is to be blocked for the non-AP STA.

10. The apparatus of claim 1, wherein the STA-initiated block request comprises a center-frequency value to indicate a center frequency of the STA-blocked frequency BW, and a BW value to indicate a BW of the STA-blocked frequency BW.

11. The apparatus of claim 1, wherein the STA-initiated block request comprises a blocked Resource Unit (RU) field comprising a predefined RU-set value selected from a plurality of predefined RU-set values mapped to a plurality of predefined RU sets, respectively, wherein the predefined RU-set value is to indicate a set of one or more RUs having an overlap with the STA-blocked frequency BW.

12. The apparatus of claim 1, wherein the STA-initiated block request is configured to indicate a request from the non-AP STA to the AP to block the STA-blocked frequency BW for any data transmission from the AP to the non-AP STA.

13. The apparatus of claim 1, wherein the STA-initiated block request is configured to indicate a request from the non-AP STA to the AP to block the STA-blocked frequency BW for any Resource Unit (RU) allocation to be provided by the AP to the non-AP STA.

14. The apparatus of claim 1 configured to cause the non-AP STA to identify the STA-blocked frequency BW based on an identified interference over the STA-blocked frequency BW.

15. The apparatus of claim 1 configured to cause the non-AP STA to identify the STA-blocked frequency BW based on an identified platform interference over the STA-blocked frequency BW, the identified platform interference comprises interference from one or more platform components of a platform comprising the non-AP STA.

16. The apparatus of claim 1 configured to cause the non-AP STA to identify the STA-blocked frequency BW based on an identified interference from a memory of a platform comprising the non-AP STA.

17. The apparatus of claim 1 configured to cause the non-AP STA to identify the STA-blocked frequency BW based on one or more real-time operation parameters of one or more platform components of a platform comprising the non-AP STA.

18. The apparatus of claim 1 comprising a radio to transmit the STA-initiated block request to the AP, one or more antennas connected to the radio, and a processor to execute instructions of an operating system.

19. A product comprising one or more tangible computer-readable non-transitory storage media comprising instructions operable to, when executed by at least one processor, enable the at least one processor to cause a non Access Point (AP) (non-AP) station (STA) to:
identify at least one STA-blocked frequency bandwidth (BW) to be blocked for communication between the non-AP STA and an AP in a wireless communication frequency channel; and
transmit a STA-initiated block request to the AP, the STA-initiated block request configured to indicate a request from the non-AP STA to the AP to block the STA-blocked frequency BW for the communication between the non-AP STA and the AP.

20. The product of claim 19, wherein the instructions, when executed, cause the non-AP STA to process a response from the AP to identify whether or not the STA-initiated block request is approved by the AP.
